(19) United States
(12) Patent Application Publication
(10) Pub. No.: US 2026/0254978 A1
(43) Pub. Date: Aug. 27, 2026

(54) TRIPLANE REPRESENTATION FOR EVENT STREAM AND HIGH TEMPORAL RESOLUTION VIDEO COMPRESSION

(71) Applicant: DOLBY LABORATORIES LICENSING CORPORATION, San Francisco, CA (US)

(72) Inventors: Jingxi CHEN, McLean, VA (US); Anustup Kumar Atanu CHOUDHURY, Campbell, CA (US); Guan-Ming SU, Fremont, CA (US)

(73) Assignee: DOLBY LABORATORIES LICENSING CORPORATION, San Francisco, CA (US)

(21) Appl. No.: 19/466,094

(22) Filed: Jan. 30, 2026

Related U.S. Application Data
(60) Provisional application No. 63/753,765, filed on Feb. 4, 2025.

(30) Foreign Application Priority Data
May 14, 2025 (EP) 25176315.7

(51) Int. Cl. H04N 19/31; H04N 19/136; H04N 19/42

(52) U.S. Cl. CPC H04N 19/31; H04N 19/136; H04N 19/42

(57) ABSTRACT

Methods and systems are described to encode an event stream. In addition, the device may receive an event stream. The device further may, encode the event stream into a plurality of triplane representations by, binning the events in the event stream into a plurality of event voxels, and encoding the plurality of event voxels into the plurality of triplane representations using an autoencoder.

### CROSS-REFERENCE TO RELATED APPLICATIONS

This application claims the benefit of priority from U.S. Provisional Patent Application No. 63/753,765, filed on Feb. 4, 2025, and EP patent application Ser. No. 25/176,315.7 filed on May 14, 2025, each of which is incorporated by reference herein in its entirety.

### TECHNOLOGY

The present invention relates generally to image processing. More particularly, an embodiment of the present invention relates to using a triplane representation for event stream and high temporal resolution video compression.

### BACKGROUND

Event cameras, also known as dynamic vision sensors (DVS), record changes in the scene by capturing events, which are changes in brightness, rather than capturing frames at fixed intervals. This allows event cameras to operate asynchronously and continuously, responding to changes in the visual scene with high temporal resolution and low latency. Event cameras offer advantages over traditional frame-based cameras in terms of speed, dynamic range, and power efficiency, these advantages make them particularly useful in applications like robotics, surveillance, and autonomous vehicles where real-time processing of visual information is critical. Besides the applications in the autonomous systems, event cameras also show the unique advantages in the computational imaging/photography that utilizes the motion information embedded in the event stream for the high-speed motion imaging and event-based video frame interpolation (EVFI).

With the advancement of recent deep learning-based approaches, many studies have explored using learning-based methods for event streams in applications such as depth estimation, optical flow estimation, EVFI, intensity video reconstruction, and deblurring. Despite the variety of networks employed, a central question remains underexplored: what representation can be used? Neural networks require fixed-length and unified representations, which poses a challenge given the numerous and variable-length event streams produced by event cameras. To address this issue, the commonly simplified choices are event frames and event voxels. This simplification works for most downstream tasks that do not require the output to be in the same form as the original event stream. This is because it is difficult to near impossible to retrieve back the original event stream from these event representations. However, this issue becomes prominent in the current era of Generative Artificial Intelligence, because if an events stream is to be generated, a unified and compressed representation for event stream is needed. This is because diffusion models can only generate fixed-length and short sequence and to date no work has been done on generating event streams due to the lack of a suitable representation for generative event modeling.

### BRIEF DESCRIPTION OF THE DRAWINGS

The present invention is illustrated by way of example and not limitation in the figures of the accompanying drawings in which like references indicate similar elements.

FIG. 1 shows an example of a system that can be used in one or more embodiments of the invention.

FIG. 2 shows an example of an illustration of an event representation that can be used in one or more embodiments of the invention.

FIG. 3 shows an example of an event stream that is transmitted using an event stream representation that can be used with one or more embodiments of the invention.

FIG. 4 shows an example of a two-stage training of an autoencoder that can be used with one or more embodiments of the invention.

FIG. 5 shows an example of the first stage training that can be used with one or more embodiments of the invention.

FIG. 6 shows an illustration of modeling events inside a voxel using Poisson Distribution based encoding/decoding that can be used with one or more embodiments of the invention.

FIG. 7 shows a second stage training for regressing the event distribution within each voxel that can be used with one or more embodiments of the invention.

FIG. 8 shows, in a flow diagram, an example of a process for training a voxel-based triplane autoencoder that can be used with one or more embodiments of the invention.

FIG. 9 shows an illustration of autoencoding pipeline 900 for inferring an event stream that can be used with one or more embodiments of the invention.

FIG. 10 shows, in a flow diagram, an example of a process for transmitting triplanes to a receiving device that can be used with one or more embodiments of the invention.

FIG. 11 shows, in a flow diagram, an example of a process for receiving and processing triplanes to reconstruct the event stream that can be used with one or more embodiments of the invention.

FIG. 12 shows an example of a data processing system that can be used to perform or implement one or more embodiments of the invention.

### DETAILED DESCRIPTION

Various embodiments and aspects will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments.

Reference in the specification to “one embodiment” or “an embodiment” means that a particular feature, structure, or characteristic described in conjunction with the embodiment can be included in at least one embodiment. The appearances of the phrase “in one embodiment” in various places in the specification do not necessarily all refer to the same embodiment. The processes depicted in the figures that follow are performed by processing logic that comprises hardware (e.g., circuitry, dedicated logic, etc.), software, or a combination of both. Although the processes are described below in terms of some sequential operations, it should be appreciated that some of the operations described may be performed in a different order. Moreover, some operations may be performed in parallel rather than sequentially.

The embodiments described herein can be used in apparatuses which include one or more processors in a processing system, and which include memory and which are configured to perform any one of the methods described herein. Moreover, the embodiments described herein can be implemented using non-transitory machine-readable storage media storing executable computer program instructions which when executed by a machine cause the machine to perform any one of the methods described herein.

The embodiments described herein can be used to optimize a computation of a video quality metric. In one embodiment, Event cameras, also known as dynamic vision sensors (DVS), record changes in the scene by capturing events, which are changes in brightness, rather than capturing frames at fixed intervals. This allows event cameras to operate asynchronously and continuously, responding to changes in the visual scene with high temporal resolution and low latency. In one embodiment, event cameras can offer advantages over traditional frame-based cameras in terms of speed, dynamic range, and power efficiency, these advantages make them particularly useful in applications like robotics, surveillance, and autonomous vehicles where real-time processing of visual information is critical. Besides the applications in the autonomous systems, event cameras also show the unique advantages in the computational imaging/photography that utilizes the motion information embedded in the event stream for the high-speed motion imaging and event-based video frame interpolation (EVFI).

With the advancement of recent deep learning-based approaches, many studies have explored using learning-based methods for event streams in applications such as depth estimation, optical flow estimation, EVFI, intensity video reconstruction, and deblurring. Despite the variety of networks employed, a central question remains underexplored: what representation can be used? Neural networks require fixed-length and unified representations, which poses a challenge given the numerous and variable-length event streams produced by event cameras. To address this issue, the commonly simplified choices are event frames and event voxels. This simplification works for most downstream tasks that do not require the output to be in the same form as the original event stream. This is because it is difficult to near impossible to retrieve back the original event stream from these event representations. However, this issue becomes prominent in the current era of Generative Artificial Intelligence, because if an events stream is to be generated, a unified and compressed representation for event stream is needed. This is because diffusion models can only generate fixed-length and short sequence and to date no work has been done on generating event streams due to the lack of a suitable representation for generative event modeling.

In addition to a unified representation of event streams for the ease of applying learning-based approaches, one potential application of such a representation is high temporal resolution video transmission and compression. For example, assume that a 500 FPS (Frames Per Second) video of high-speed motion transmission is desired. Transmitting directly at 500 FPS is costly due to the high temporal resolution. However, with events, a 50 FPS low temporal resolution video can be transmitted, where corresponding events between these low temporal resolution key frames can be used to perform event-based video frame interpolation (EVFI) and reconstruct the original 500 FPS high temporal resolution video. The transmission cost shown below: costₐₗₗ is the cost of storing both 50 FPS videos and events stream, cost_{org} is the cost for storing 500 FPS, costₑᵥₑₙₜ is the cost to store the event stream data.

$${cost}_{all} = \frac{{cost}_{org}}{10} + {cost}_{event} \qquad ( 1 )$$

As can be seen, the limitation of the EVFI-based approach lies in the cost of transmitting the event stream. If this challenge can be addressed, the compression rate could be ten times higher than the current state-of-the-art methods. Currently, no well-known methods can both compress and decompress the entire event stream.

Based on the above needs and insights, a Triplane-based autoencoder method is proposed. This method leverages the fact that event sequences are naturally interarrival sequences, whose statistics can be described by a Poisson distribution. This approach inherits the merits of voxel-based Triplane methods and leverages the power of probabilistic encoding for handling large amounts of data points, enabling both compression and reconstruction of the original event stream. Through evaluations in downstream tasks such as EVFI and intensity frame reconstruction, the effectiveness of reconstructing the event stream can be demonstrated from the encoded Triplanes with probabilistic of event distribution.

A Triplane and probabilistic-based autoencoder framework for the unified and compressed representation of event streams is proposed. In one embodiment, a two-stage training scheme of the event stream autoencoder is proposed, by training a simpler and standard voxel-based autoencoder in the first stage and training the regression-based autoencoder for event distribution parameters inside each voxel in the second stage. In this embodiment, the training process is modified with regards to the usage of triplanes (e.g., concatenation instead of summation) for better representation. In one embodiment, a triplane is a decomposition a three-dimensional (3D) space into three two-dimensional (2D) planes. For example, a 3D point (x, y, z) is represented by point in 3 2D planes in (x,y) in 1^{st} plane, (x,z) in the 2^{nd} plane, and (y,z) in the 3^{rd} plane. In this embodiment, note that each 2D plane can actually have the 3^{rd} dimension to store the feature vector. So, technically, the “plane” is 3D, the first 2 dimension is spatial coordinate, the 3^{rd} dimension is the feature axis. In one embodiment, a triplane can be represented as three axis-aligned triplanes as h=[h^{xy}, h^{xz}, h^{yz}]. In this embodiment, each of these triplanes can be characterized by distinct dimensional properties: h^{xy}∈R^{C}^{ₕ}^{×X}^{ₕ}^{×Y}^{ₙ}, h^{xz}∈R^{C}^{ₕ}^{×X}^{ₕ}^{×Z}^{ₕ}, h^{yz}∈R^{C}^{ₕ}^{×Y}^{_{h×}}^{Z}^{ₙ}, where Cₕ stands for a feature dimension, and Xₕ, Yₕ, and Zₕ denote spatial dimensions of the triplane.

Furthermore, a Poisson Distribution based probabilistic encoding of event stream inside a voxel is proposed that can greatly reduce the parameters to represent an event stream and make the regression-based autoencoder training feasible to reconstruct events in the original stream form. The proposed methods can also enable diffusion models for generating event stream data, since it can encode the event stream into triplanes which is a suitable format to the diffusion model process.

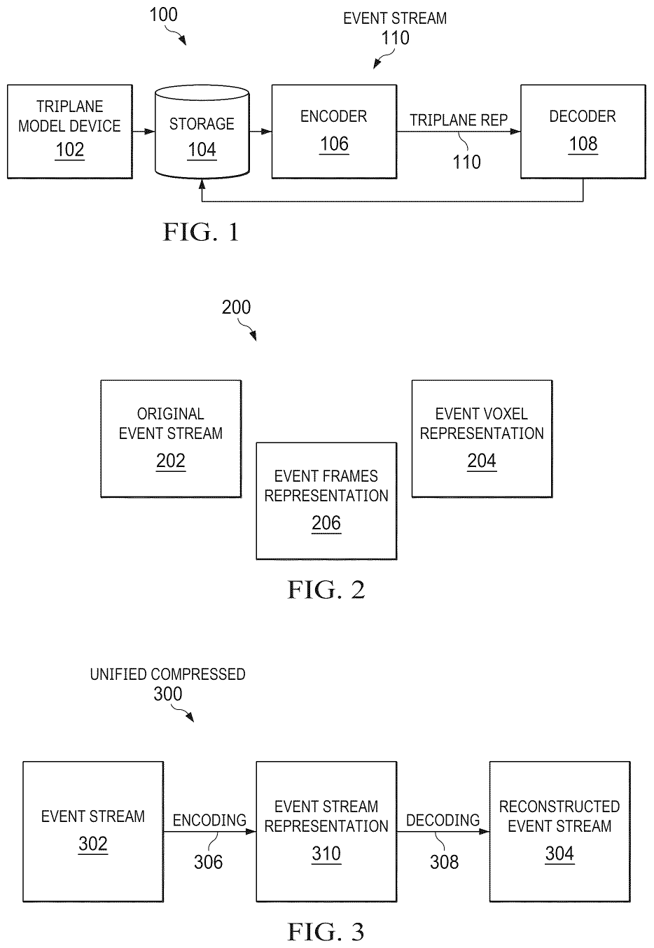

FIG. 1 shows an example of a system 100 that can be used in one or more embodiments of the invention. In one embodiment, the system 100 includes a triplane model device 102 coupled to storage 104. In this embodiment, the triplane model device 102 trains a voxel-based autoencoder, where the storage 104 stores the voxel-based autoencoder. In addition, the storage is coupled to an encoder 106, that retrieves voxel-based autoencoder, which the encoder 106 generates and sends triplane representation 110 from an event stream. The encoder 106 sends the triplane representation 110 to a decoder 108. In addition, the decoder 108 retrieves the voxel-based autoencoder. The decoder 108 uses the voxel-based autoencoder and the triplane representation 110 to reconstruct the event stream.

In one embodiment, the encoder 106, decoder 108, and/or triplane model device 102 can independently be a server, personal computer, laptop, camera, smartphone, or another device that can process an event stream and/or a triplane representation.

FIG. 2 shows an example of an illustration of an event representation 200 that can be used in one or more embodiments of the invention. In FIG. 2, there are different event representations: the original event stream (202), event voxels (204), and different type of event frames (206). In one embodiment, the common thing between the different representations is that they are the accumulated or binned format of the original event stream which makes them fixed length and compressed representations that be used for downstream applications involving neural networks. However, the common issue of them is that you can never get back the original event stream from these accumulated/binned representations.

In one embodiment, a unified and compressed event stream representation that can be used to encode and decode back the original event stream form and can be used in a diffusion model framework to generate events is presented. Given an event stream with N number of events in the format E:

$${\{ ( {x}_{i} , {y}_{i} , {p}_{i} , {t}_{i} ) \}}_{i = 1}^{N} ,$$

where x, y are spatial location of events, t is the timestamp, and p is the polarity. The number of events can be varied and numerous. As shown in FIG. 3 below, an autoencoder converts these numerous and variable events in event streams into unified (fixed-length) and compressed event stream representation that is capable to reconstruct the original stream format. Furthermore, for the autoencoder, the representation is to be conducive to a diffusion model framework so that events can be generated. The total bits of the event stream representation will always be fixed and significantly less than the total bits of the original event stream. FIG. 3 shows an example of an event stream 300 that is transmitted using an event stream representation that can be used with one or more embodiments of the invention. In FIG. 3, an autoencoder is created that encodes and decodes the event stream to unified and compressed embedding vectors consists of two stages. In one embodiment, the autoencoder encodes (306) an event stream 302 to generate an event stream representation 310 that is unified and compressed. In a further embodiment, a decoder receives the event stream representation 310 and decodes (308) the event stream representation 310. By decoding the event stream representation 310, the decoder reconstructs the event stream 304. While in one embodiment, the encoder and decoder functions of the autoencoder are performed by different devices using the same or different executables, in alternate embodiments, the encoder and decoder functions of the autoencoder can be performed on the same device using the same or different executables.

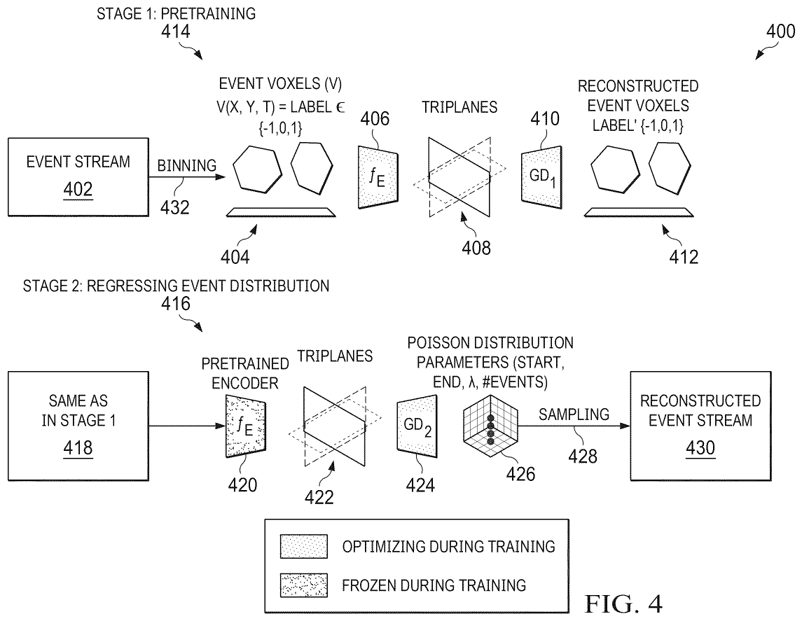

In FIG. 3, an autoencoder is used to encode and decode the event stream representation that can be transmitted between different devices. In one embodiment, the autoencoder is trained to be used for encoding and/or decoding processes. In this embodiment, the training is a two-stage training, where stage 1 is a pretraining of voxel-based triplane autoencoder and stage 2 is a regressing to predict the event distribution within each voxel. FIG. 4 shows an example of a two-stage training 400 of an autoencoder that can be used with one or more embodiments of the invention. In one embodiment, the training initially includes a pre-training of the autoencoder (encoder f_{E}, decoder g_{D}_{₁}) on a simplified task that involves binned event voxels (V). In FIG. 4, the training 400 begins by receiving the original event stream 402 that is used for training. In addition, the event stream is binned 432 into event voxels 404. In one embodiment, the original stream will first be binned into fixed-length event voxels, as shown in Equation (1) and (2), V^{H×W×T} of size H×W×T. At an event voxel location (x, y, t), V (x, y, t)=Label∈{−1, 0, 1}, where −1 means the most polarities (sign of the sum of polarity in Equation (2)) of events in the voxel (x, y, t) is negative, 0 means the voxel (x, y, t) is empty, 1 means the most polarities of events in the voxel (x, y, t) is positive.

$${\{ ( {x}_{i} , {y}_{i} , {p}_{i} , {t}_{i} ) \}}_{i ∈ \{ 1 , 2 , … , N \}} \to {V}^{H \times W \times T} \qquad ( 1 )$$

$$V ( x , y , t ) = sign ( {\sum }_{k = 0}^{n} {p}_{k} ) \qquad ( 2 )$$

In one embodiment, the height (H) and width (W) are chosen to match an original spatial resolution of the events, and binning will be performed in the temporal dimension. In another embodiment, the binning can be performed in another dimension using the same or different spatial resolution. For example, and in one embodiment, given a events stream of spatial resolution 512×512, and time duration 210 milliseconds, the choice of the event voxel size V is 512×512×32. In this example, each voxel has the same spatial resolution as the original stream and around contains around 7 millisecond events.

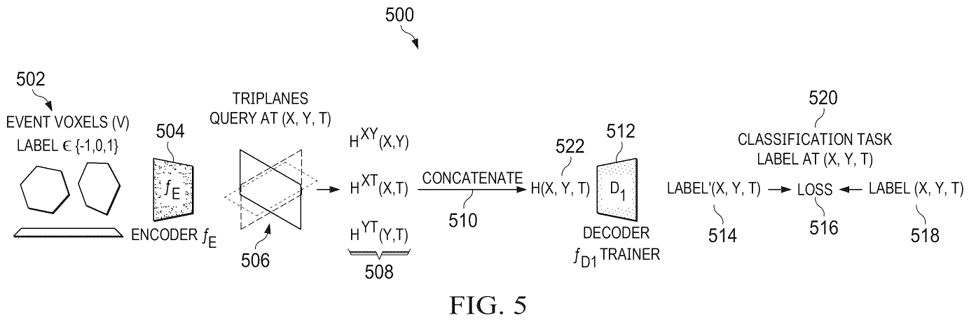

FIG. 5 shows an example of the first stage training 500 that can be used with one or more embodiments of the invention. In FIG. 5, the event voxels 502 are encoded using the encoder (f_{E}) 504 to generate triplane query 506. In one embodiment, the first stage training concatenates h^{y}, h^{xz}, h^{yz} (508) channel wise to get h(p)=concatenate (h^{xy}, h^{xz}, h^{yz}) (510), as an example if h^{xy}∈R^{16×256×256}, h^{xz}∈R^{16×256×256}, h^{yz}∈R^{16×256×256}, then h(p)∈R^{48×256×256} In another embodiment, h^{xy}, h^{xz}, h^{yz} can be summed to get h(p)=h^{xy}+h^{xz}+h^{yz}. This will make h(p) (522) with more representation power than summation one. In one embodiment, an issue with binning in a temporal direction can result in event voxels having much lower temporal resolution compared to the original event stream, thus making it impossible to reconstruct back the original event stream.

In one embodiment, a decoder (g_{D}_{₁}) 512 decodes h(p) (522) to generate a set of labels (x, y, t) 514. The generated labels 514 are compared with a set of known labels to determine a loss 516. The loss can be used by a loss function (not illustrated) to determine any updates to the encoder (f_{E}) 504 and/or decoder (g_{D}_{₁}) 512. Once the loss is within a convergence criteria, the encoder (f_{E}) 504 and/or decoder (g_{D}_{₁}) 512 would be trained.

However, the issue with this approach is that binning in the temporal direction will result in event voxels having much lower temporal resolution compared to the original event stream, thus making it impossible to reconstruct back the original event stream.

In one embodiment, because the event voxels have the same spatial resolution as the original event stream, the compression can be along the time axis. In this embodiment, the way to represent the distribution of events along the time axis is to be determined. It turns out naturally since the events are occurrence sequence of logarithmic brightness change at a sensor location exceeds a certain threshold, the number of occurrence of events in a certain interval follows the Poisson distribution.

In one embodiment, to model the distribution of events along the time axis, it can be represented that an event sequence as X and the inter-arrival time between two consecutive events as W. In one embodiment, the number of events occurrences X follow the poisson distribution. The interarrival times W between them follows the exponential distribution.

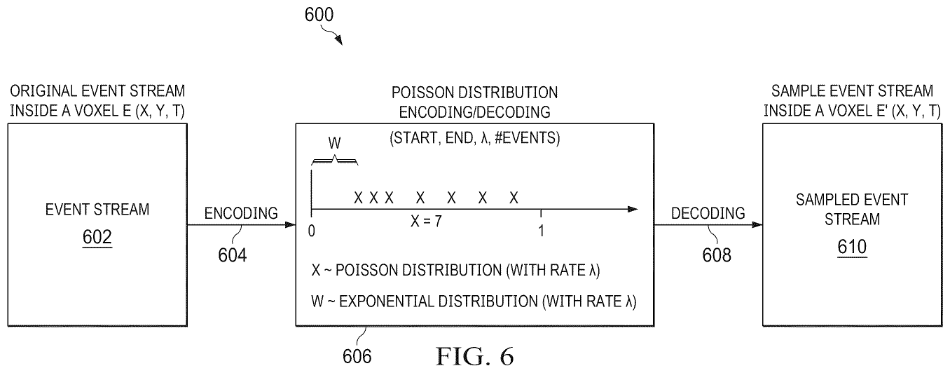

FIG. 6 show an illustration of modeling events 600 inside a voxel using poisson Distribution based encoding/decoding that can be used with one or more embodiments of the invention. In FIG. 6, the modeling events 600 beings with an original event stream in a voxel E(x, y, t) 602 that in encoded (604) resulting in a poison distribution 606. In one embodiment, the events sequences (X) have a poison distribution with rate λ. In addition, the interarrival times between the events in the event stream (W) have an exponential distribution with a rate λ. This Poisson distribution can be decoded (608) into a sampled event stream inside a voxel E′ (x, y, t) (610).

In one embodiment, an encoding of the event stream at a voxel (x, y, t) begins by normalizing timestamps. In one embodiment, normalizing timestamps occurs by taking the event timestamps

$${\{ {x}_{k} \}}_{k = 1}^{K}$$

inside a voxel and normalize them to range [0, 1]. Furthermore, the interarrival times are calculated. For example, and in one embodiment, the interarrival time is computed as wₖ₋₁=xₖ−xₖ₋₁. In addition, statistics are computed, where the statistics are statistics of event occurrence sequence: starting time

$$Start = min ( {\{ {x}_{k} \}}_{k = 1}^{K} ) ,$$

ending time

$$End = max ( {\{ {x}_{k} \}}_{k = 1}^{K} ) ,$$

average waiting time and

$$\frac{1}{λ} = \frac{{\sum }_{k = 2}^{K} ( {x}_{k} - {x}_{k - 1} )}{N - 1} ,$$

and #events=K. This results in a collection of {Start, End}, λ, and a number of events (#events).

For the decoding, in one embodiment, an exponential distribution is determined. In this embodiment, the exponential distribution is a waiting time distribution represented by:

$$Expon ( {w}_{i} ; λ ) = {λe}^{- {λw}_{i}} , for {w}_{i} > 0 , otherwise 0 \qquad ( 3 )$$

In addition, the times of the events are sampled by Sampling Expon (wᵢ; λ) for #events times and get back the sampled events timestamps

$${x}_{k}^{′}$$

with following formula (4):

$${x}_{k}^{′} = {\sum }_{n = 1}^{i - 1} {w}_{n} \qquad ( 4 )$$

And re-normalizing sampled time stamps by formula (5):

$${x}_{k}^{′} = {x}_{k}^{′} * ( {End}^{′} - {Start}^{′} ) + {Start}^{′} \qquad ( 5 )$$

Returning to FIG. 4 above, the second stage uses the first encoder (f_{E}) and further trains a second decoder for regressing event distribution 416. In the Stage 1 training, the issue of learning the voxel-based triplane autoencoder (encoder f_{E}, decoder g_{D}_{₁}) can help reconstruct the event voxels but it is still a binned representation and far from getting back the original event stream. From the discussion above on the distribution of events within each voxel along the time axis, the events occurrence inside each voxel follows the Poisson distribution with inter-arrival time being exponential distribution.

In one embodiment, the second training uses the trained first encoder (f_{E}) and trains decoder g_{D}_{₂} to regress the (Start, End, λ, #events), where is Start∈[0, 1] is the start time of event occurrence sequence in a voxel, End∈[0, 1] is the end time of event occurrence sequence, λ∈[0, ∞) is the mean of the interarrival rate of event sequence, #events∈[0, ∞) is the number of events in the sequence. This leads to the regression task triplane autoencoder training Loss [symbol] _{R}:

$${ℒ}_{R} = {E}_{p ∼ P} [ {l}_{2} ( r ( p ) , {r}^{′} ( p ) ) ] \qquad ( 2 )$$

where l₂ is L2 loss, r(p)=[Start, End, λ, #events] are the ground truth event distribution parameters and r′(p)=[Start′, End′, λ′, #events′] are the predicted event distribution parameters from the model.

In a further embodiment, the architecture of decoder g_{D}_{₂} is the same as g_{D}_{₁} in the Stage 1 training except three new heads are added consisting of multi-layer perceptions (MLP):
Sigmoid MLP: MLP layers with a Sigmoid activation to output range [0, 1] for Start′ and End′
RELU MLP: MLP layers with a ReLU activation output range [0, ∞) for λ and #events separately
   In another embodiment, this training can be used to predict the logarithm value log(λ) and log (#events) for the stability of the training.

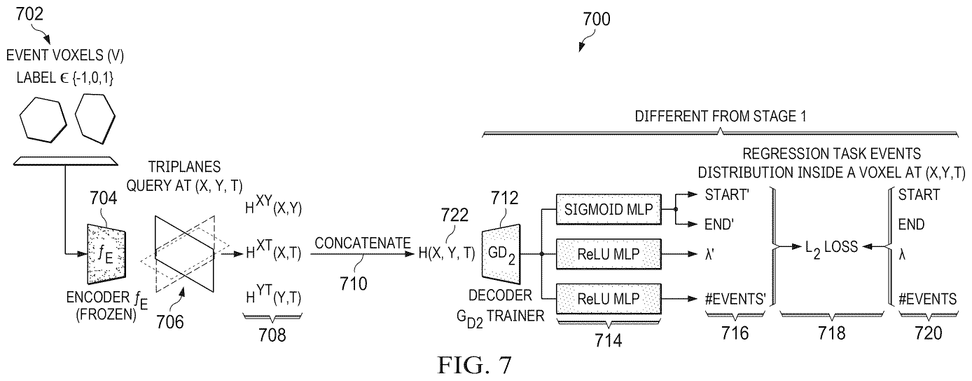

FIG. 7 shows a second stage training 700 for regressing the event distribution within each voxel that can be used with one or more embodiments of the invention. In FIG. 7, the second stage training 700 begins similarly to the first stage by receiving the original event stream (702) and binning the event stream into voxels as described in FIGS. 4 and 5 above. The trained first encoder (f_{E}) encodes (704) the voxels to create the triplane query (706) and (708), which are concatenated (710) to produce h(x, y, t) 722 as described in FIG. 5 above. In one embodiment, and different from the first stage training, the second stage uses a second decoder (g_{D}_{₂}) (712) that regresses (714) the (Start, End, λ, #events) (716). The regressed (Start, End, λ, #events) (716) is compared with a set of known (Start, End, λ, #events) (720) to determine a loss 718 between the two sets of (Start, End, λ, #events). The loss 718 can be used by a loss function (not illustrated) to determine any updates to the decoder (g_{D}_{₂}) 712. Once the loss is within a convergence criteria, the decoder (g_{D}_{₂}) 512 would be trained.

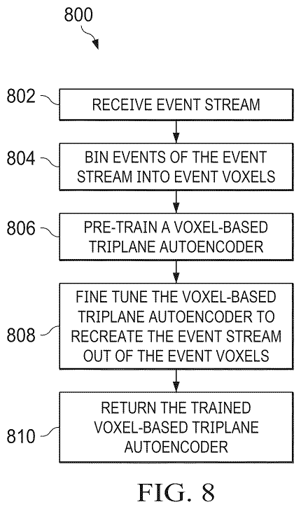

FIG. 8 shows, in a flow diagram 800, an example of a process 400 for training a voxel-based triplane autoencoder that can be used with one or more embodiments of the invention. In one embodiment, a triplane device trains the voxel-based triplane autoencoder, such as triplane device 102 as illustrated in FIG. 1 above. In FIG. 8, process 800 begins by receiving the event stream at block 802. In one embodiment, process 800 receives the event stream at block 802. In one embodiment, process 800 receives the event stream that is a known event stream that is used for training the voxel-based triplane autoencoder. In one embodiment, process 800 receives the event stream as described in FIG. 4 above. At block 804, process 800 bins events of the event stream into event voxels. In one embodiment, a voxel is the three-dimensional equivalent of a pixel, representing a single unit of volume within a 3D space. In one embodiment, process 800 bins the events into fixed length event voxels as described in FIGS. 4 and 5 above.

At block 806, process 800 pre-trains a voxel-based triplane autoencoder. In one embodiment, process 800 pre-trains the voxel-based triplane autoencoder by training an encoder (f_{E}) that generates triplane query and a first decoder (g_{D}_{₁}) that decodes the triplane query as described in FIG. 5 above. Process 800 fine tunes the voxel-based triplane autoencoder at block to recreate the event stream out of the event voxels at block 808. In one embodiment, process 800 fine tunes the voxel-based triplane autoencoder by training a second decoder (g_{D}_{₂}) as described in FIG. 7 above. At block 810, process 800 returns the voxel-based triplane autoencoder. In one embodiment, process 800 stores the voxel-based triplane autoencoder in storage, such as storage 104 as illustrated in FIG. 1 above. In this embodiment, the trained voxel-based triplane autoencoder can be used to reconstruct event stream for future uses.

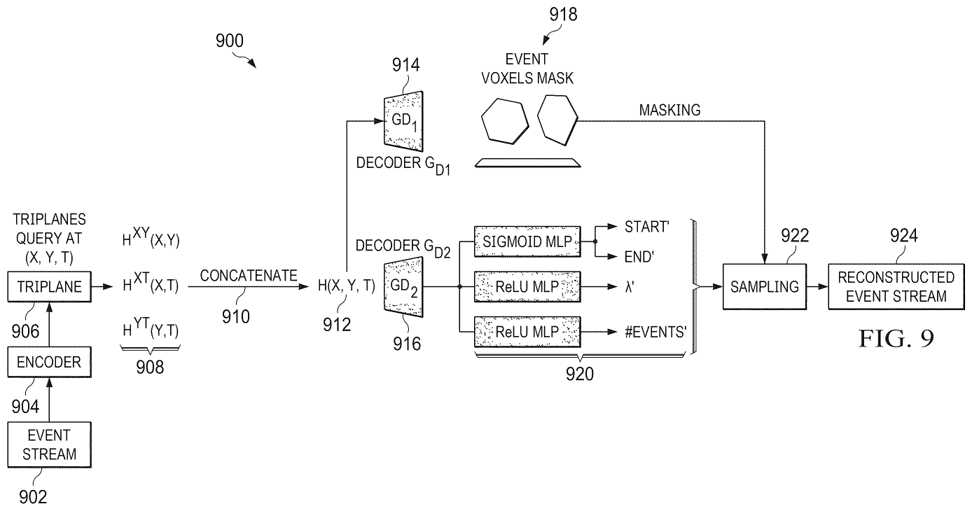

In one embodiment, the trained voxel-based triplane autoencoder can be used to encode and decode an event stream between different (or the same devices). FIG. 9 shows an illustration of autoencoding pipeline 900 for inferring an event stream that can be used with one or more embodiments of the invention. In FIG. 9, pipeline 500 begins by receiving the event stream (902). In one embodiment, the event stream (902) is an event stream that was not used to train the autoencoder. The pipeline 900 encodes (904) the event stream (902). In one embodiment, the pipeline 900 encodes (904) the event stream (902) by using the trained voxel-based triplane autoencoder as described above. The encoding (904) produces the triplane query at (x, y, t). The triplane query (906) h^{xy}, h^{xz}, h^{yz} are concatenated (910) to generate h(x, y, t) (912). In one embodiment, the concatenated triplane queries 912 are the triplane representations that are transmitted from the encoder to the decoder.

In one embodiment, the pipeline 900 receives the concatenated triplane queries 912 and decodes these triplane queries 912 using two different trained decoders. The first decoder (g_{D}_{₁}) 914 decodes the triplane queries 912 into an event voxel mask 918. In addition, the second decoder (g_{D}_{₂}) 916 decodes the triplane queries 912 into (Start, End, λ, #events) tuples. In one embodiment, the decoder (g_{D}_{₂}) 916 uses a sigmoid MLP to generate the (Start, End), a ReLU to generate the λ and #events (920). Furthermore, the pipeline samples (922) the (Start, End, λ, #events) using the event voxel mask to reconstruct the event stream.

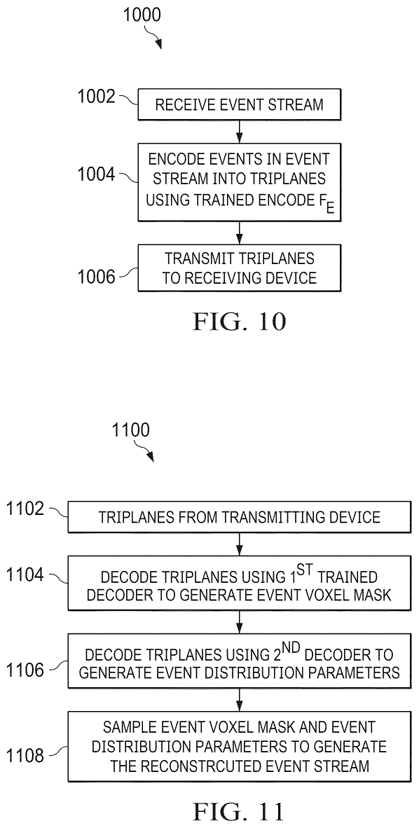

FIG. 10 shows, in a flow diagram, an example of a process 1000 for transmitting triplanes to a receiving device that can be used with one or more embodiments of the invention. In one embodiment, an encoder performs process 1000, such as the encoder 106 as illustrated in FIG. 1 above. In FIG. 10, process 1000 begins by receiving the event stream at block 1002. In one embodiment, the event stream is an event stream that was not used to train the autoencoder. Process 1000 encodes the event stream into triplanes using the trained encoder (f_{E}) at block 1004. In one embodiment, the pipeline 900 encodes the event stream by using the trained voxel-based triplane autoencoder that the trained encoder (f_{E}) as described above. In this embodiment, the encoding produces the triplane query at (x, y, t). The triplane query h^{xy}, h^{xz}, h^{yz} are concatenated to generate h(x, y, t). In one embodiment, the concatenated triplane queries are the triplane representations that are transmitted from the encoder to the decoder. At block 1006, process 1000 transmits the triplane to the receiving device.

In one embodiment, the decoding device receives the triplanes and decodes them to reconstruct the event stream. FIG. 11 shows, in a flow diagram, an example of a process 1100 for receiving and processing triplanes to reconstruct the event stream that can be used with one or more embodiments of the invention. In FIG. 11, process 1100 begins by receiving the triplanes at block 1102. In one embodiment, the triplanes are concatenated triplane queries as described in FIG. 9 above. At block 1104, process 1100 decodes the triplanes using a first trained decoder (g_{D}_{₁}) to generate the event voxel mask. In one embodiment, process 1100 decodes the triplanes with the first trained decoder (g_{D}_{₁}) to generate the event voxel mask as described in FIG. 9 above. Process 1100 decodes the triplanes using a trained second decoder (g_{D}_{₂}) into (Start, End, λ, #events) tuples at block 1106. In one embodiment, process 1100 decodes the triplanes with the second trained decoder (g_{D}_{₂}) to generate the (Start, End, λ, #events) tuples as described in FIG. 9 above. At block 1108, process 1100 samples the event voxel mask and event distribution parameters to generate the reconstructed event stream. In one embodiment, process 1100 samples the event voxel mask and event distribution parameters as described in FIG. 9 above.

In one embodiment, the trained event voxel-based autoencoder improves the working of the computer by compressing the event stream. For example, and in one embodiment, given 915204 events of {x, y, t, p}, where x and y are 32 bits, tis 64 bits and p is 2 bits. In this example, the triplane representation with spatial resolution 512×512 and temporal resolution 32 is used. The compression rate in bits then will be:

$$\frac{915204 * ( 32 * 2 + 64 + 2 )}{( ( 16 \times 256 \times 256 + 16 \times 256 \times 32 + 16 \times 256 \times 32 ) * 16 )} = 6.24$$

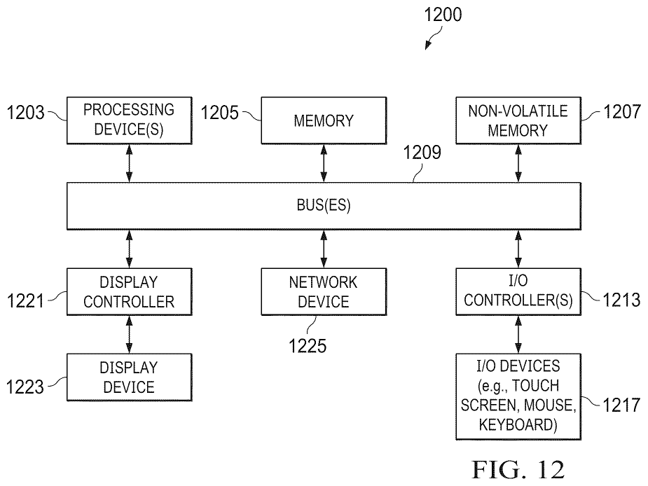

FIG. 12 shows an example of a data processing system 1200 that can be used by or in a camera or other device to provide one or more embodiments described herein. The systems and methods described herein can be implemented in a variety of different data processing systems and devices, including general-purpose computer systems, special purpose computer systems, or a hybrid of general purpose and special purpose computer systems. Data processing systems that can use any one of the methods described herein include a camera, a smartphone, a set top box, a computer, such as a laptop or tablet computer, embedded devices, game systems, and consumer electronic devices, etc., or other electronic devices.

FIG. 12 is a block diagram of data processing system 1200 hardware according to an embodiment. Note that while FIG. 12 illustrates the various components of a data processing system, it is not intended to represent any particular architecture or manner of interconnecting the components as such details are not germane to the present invention. It will also be appreciated that other types of data processing systems that have fewer components than shown or more components than shown in FIG. 12 can also be used with one or more embodiments of the present invention.

As shown in FIG. 12, the data processing system 1200 includes one or more buses 1209 that serve to interconnect the various components of the system. The system in FIG. 12 can include a camera or be coupled to a camera. One or more processing devices 1203 are coupled to the one or more buses 1209 as is known in the art. Memory 1205 may be DRAM or non-volatile RAM or may be flash memory or other types of memory or a combination of such memory devices. This memory is coupled to the one or more buses 1209 using techniques known in the art. The data processing system can also include non-volatile memory 1207, which may be a hard disk drive or a flash memory or a magnetic optical drive or magnetic memory or an optical drive or other types of memory systems that maintain data even after power is removed from the system. The non-volatile memory 1207 and the memory 1205 are both coupled to the one or more buses 1209 using known interfaces and connection techniques. A display controller 1221 is coupled to the one or more buses 1209 in order to receive display data to be displayed on a display device which can be one of displays. The data processing system 1200 can also include one or more input/output (I/O) controllers 1215 which provide interfaces for one or more I/O devices, such as one or more cameras, touch screens, ambient light sensors, and other input devices including those known in the art and output devices (e.g., speakers). The input/output devices 1217 are coupled through one or more I/O controllers 1213 as is known in the art. The ambient light sensors can be integrated into the system in FIG. 12.

While FIG. 12 shows that the non-volatile memory 1207 and the memory 1205 are coupled to the one or more buses directly rather than through a network interface, it will be appreciated that the present invention can utilize non-volatile memory that is remote from the system, such as a network storage device which is coupled to the data processing system through a network interface such as a modem or Ethernet interface. The buses 1209 can be connected to each other through various bridges, controllers and/or adapters as is well known in the art. In one embodiment the I/O controller 1213 includes one or more of a USB (Universal Serial Bus) adapter for controlling USB peripherals, an IEEE 1394 controller for IEEE 1394 compliant peripherals, or a Thunderbolt controller for controlling Thunderbolt peripherals. In one embodiment, one or more network device(s) 1225 can be coupled to the bus(es) 1209. The network device(s) 1225 can be wired network devices (e.g., Ethernet) or wireless network devices (e.g., Wi-Fi, Bluetooth) that receive images from a camera, etc.

Although separate embodiments are enumerated below, it will be appreciated that these embodiments can be combined or modified, in whole or in part, into various different combinations. The combinations of these embodiments can be any one of all possible combinations of the separate embodiments.

Embodiment 1 is a method to encode an event stream, the method comprising: receiving an event stream; and
encoding the event stream into a plurality of triplane representations by,
   binning the events in the event stream into a plurality of event voxels, and encoding the plurality of event voxels into the plurality of triplane representations using an autoencoder.

Embodiment 2 is a method of embodiment 1, wherein the events in the event stream are binned into fixed length event voxels.

Embodiment 3 is a method of embodiment 2, wherein the binning is performed in a temporal dimension of the events in the event stream.

Embodiment 4 is a method of any previous embodiment, wherein the encoding the plurality of event voxels comprises:
encoding the plurality of event voxels using a trained encoder.

Embodiment 5 is a method of any previous embodiment, further comprising:
concatenating the plurality of triplane representations.

Embodiment 6 is a method of embodiment 5, further comprising:
transmitting the concatenated plurality of triplane representations to another device.

Embodiment 7 is a method of any previous embodiment, wherein the autoencoder is a voxel-based triple autoencoder.

Embodiment 8 is a method of any previous embodiment, wherein the autoencoder is trained by training an encoder and a first decoder.

Embodiment 9 is a method of any previous embodiment, wherein a triplane representation is a decomposition of a three-dimensional space into three two-dimensional planes.

Embodiment 10 is a method of any previous embodiment, wherein the triplane representation is a multi-resolution triplane.

Embodiment 11 is a method of any previous embodiment, further comprising:
fine-tuning the autoencoder by training a second decoder that regresses event distribution parameters.

Embodiment 12 is a method of any previous embodiment, wherein the distribution parameters are for each voxel and include one or more of a start time of an event sequence, end time of an event sequence, mean interarrival rate of an event sequence, and number of events in an event sequence.

Embodiment 13 is an apparatus comprising a processing system and memory and configured to perform any one of the methods in embodiments 1-12.

Embodiment 14 is a non-transitory machine-readable storage storing executable program instructions which when executed by a machine cause the machine to perform any one of the methods of embodiments 1-12.

Embodiment 15 is a method to decode an encoded event stream, the method comprising:
receiving the encoded event stream, wherein the encoded event stream is a triplane representation;
decoding the triplane representation using a trained first decoder to generate an event voxel mask;
decoding the triplane representation using a trained second decoder to generate a plurality of event distribution parameters; and
reconstructing from the event stream using the event voxel mask and the plurality of event distribution parameters.

Embodiment 16 is a method of embodiment 14, wherein the reconstructing from the event stream comprises:

sampling the plurality of event distribution parameters using the event voxel mask.

Embodiment 17 is an apparatus comprising a processing system and memory and configured to perform any one of the methods in embodiments 15-16.

Embodiment 18 is a non-transitory machine-readable storage storing executable program instructions which when executed by a machine cause the machine to perform any one of the methods of embodiments 15-16.

It will be apparent from this description that one or more embodiments of the present invention may be embodied, at least in part, in software. That is, the techniques may be carried out in a data processing system in response to its one or more processors executing a sequence of instructions contained in a storage medium, such as a non-transitory machine-readable storage medium (e.g., DRAM or flash memory). In various embodiments, hardwired circuitry may be used in combination with software instructions to implement the present invention. Thus, the techniques are not limited to any specific combination of hardware circuitry and software, or to any particular source for the instructions executed by the data processing system.

In the foregoing specification, specific exemplary embodiments have been described. It will be evident that various modifications may be made to those embodiments without departing from the broader spirit and scope set forth in the following claims. The specification and drawings are, accordingly, to be regarded in an illustrative sense rather than a restrictive sense.

1. A method to encode an event stream, the method comprising:
receiving an event stream; and
encoding the event stream into a plurality of triplane representations by,
binning the events in the event stream into a plurality of event voxels, and
encoding the plurality of event voxels into the plurality of triplane representations using an autoencoder.

2. The method of claim 1, wherein the events in the event stream are binned into fixed length event voxels.

3. The method of claim 2, wherein the binning is performed in a temporal dimension of the events in the event stream.

4. The method of claim 1, wherein encoding the plurality of event voxels comprises:
encoding the plurality of event voxels using a trained encoder.

5. The method of claim 1, further comprising:
concatenating the plurality of triplane representations.

6. The method of claim 5, further comprising:
transmitting the concatenated plurality of triplane representations to another device.

7. The method of claim 1, wherein the autoencoder is a voxel-based triple autoencoder.

8. The method of claim 1, wherein the autoencoder is trained by training an encoder and a first decoder.

9. The method of claim 1, wherein a triplane representation is a decomposition of a three-dimensional space into three two-dimensional planes.

10. The method of claim 9, wherein the triplane representation is a multi-resolution triplane.

11. The method of claim 1, further comprising:
fine-tuning the autoencoder by training a second decoder that regresses event distribution parameters.

12. The method of claim 1, wherein the distribution parameters are for each voxel and include one or more of a start time of an event sequence, end time of an event sequence, mean interarrival rate of an event sequence, and number of events in an event sequence.

13. An apparatus comprising a processing system and memory and configured to perform the method in claim 1.

14. A non-transitory machine-readable storage storing executable program instructions which when executed by a machine cause the machine to perform the method of claim 1.

15. A method to decode an encoded event stream, the method comprising:
receiving the encoded event stream, wherein the encoded event stream is a triplane representation;
decoding the triplane representation using a trained first decoder to generate an event voxel mask;
decoding the triplane representation using a trained second decoder to generate a plurality of event distribution parameters; and
reconstructing from the event stream using the event voxel mask and the plurality of event distribution parameters.

16. The method of claim 15, wherein the reconstructing from the event stream comprises:
sampling the plurality of event distribution parameters using the event voxel mask.

17. An apparatus comprising a processing system and memory and configured to perform the method in claim 15.

18. A non-transitory machine-readable storage storing executable program instructions which when executed by a machine cause the machine to perform the method of claim 15.
